(19) United States
(12) Patent Application Publication
(10) Pub. No.: US 2007/0219402 A1
(43) Pub. Date: Sep. 20, 2007

(54) Encapsulation Of Hazardous Waste Materials

(76) Inventors: Ian Hugh Godfrey, Cumbria (GB); Edward John Butcher, Cumbria (GB); Joanne Louis Parr, Cumbria (GB)

Correspondence Address: SEYFARTH SHAW LLP, 131 S. DEARBORN ST., SUITE2400, CHICAGO, IL, 60603-5803, US

(21) Appl. No.: 10/599,897

(22) PCT Filed: Apr. 13, 2005
(86) PCT No.: PCT/GB05/01423

§ 371 Date: Feb. 26, 2007

(30) Foreign Application Priority Data
Apr. 13, 2004 (GB) 0408113.9

(51) Int. Cl. G21F 9/28

(52) U.S. Cl. 588/3

(57) ABSTRACT

The invention provides a method for the encapsulation of uranium metal which comprises treating the metal with an encapsulant which comprises a cementitious material and curing the cementitious material, the process additionally comprising the provision of means for the minimisation of the corrosion of the metal. Suitable modes for the provision of means for the minimisation of corrosion include the provision of a source of oxygen within the cement matrix, either by facilitating enhanced oxygen access from the atmosphere using air entraining agents or cenospheres or by the inclusion of an independent source of oxygen, for example a peroxide. An alternative mode for the provision of means for the minimisation of corrosion comprises facilitating the minimisation of the water content of the matrix, which is conveniently achieved by the addition of superplasticisers. The method allows for the long team storage of uranium metal and provides significant benefits in terms of health, safety and the environment.

### FIELD OF THE INVENTION

This invention relates to a method for the treatment and storage of hazardous materials by encapsulation. More specifically, it is concerned with the encapsulation in cementitious media of uranium metal in a mariner which minimises corrosion of the metal and the production of hydrogen during prolonged storage.

### BACKGROUND OF THE INVENTION

Encapsulation has proved to be an especially favoured method for the disposal of certain hazardous materials; specifically it provides a suitable means for the conversion of these materials into a stable and safe form, which allows for long-term storage and/or ultimate disposal. The technique finds particular application in the nuclear industry, where the highly toxic and radioactive nature of the materials involved, and the extended timescales over which the toxicity is maintained, are the principal considerations when devising safe disposal methods.

In WO-A-03/056571, the present applicant has disclosed the use of cementitious grouting materials for the encapsulation of fine particulate sized wastes and provided details of a method for the encapsulation of fine particulate materials which comprises treating these materials with at least one microfine hydraulic inorganic filler.

The use of cement based injection grouting in the construction industry is well known from the prior art. Thus, EP-A-412913 teaches the use of a Portland Cement based grout in the consolidation of concrete structures affected by fine cracks, providing a cost-effective means of infilling both superficial and deeper fissures and cavities in such structures, including such as buildings, bridges and dams. Similarly, ZA-A-9209810 is concerned with a pumpable, spreadable grouting composition incorporating a cementitious and/or pozzolanic or equivalent material, and its application in sealing fissures and cracks, back-filling, providing mass fills in civil and mining works, or lining tunnels.

Also disclosed in the prior art are hydraulic setting compositions comprising particles of Portland Cement together with fine particles of silica fume containing amorphous silica, which are the subject of EP-A-534385 and are used in the production of concrete, mortar or grout having improved fluidity, whilst GB-A-2187727 describes a rapid gelling, hydraulic cement composition which comprises an acrylic gelling agent, a fine filler and Portland Cement, this composition being thixotropic and finding particular application in the formation of bulk infills for underground mining, and in the filling of voids and cavities in construction or civil engineering. A composition which also is useful in general building and construction work, and as an insulating material comprises a particulate filler, cellulose fibres and a cementitious binder, and is disclosed in GB-A-2117753.

Whilst the majority of these compositions of the prior art have a requirement for the addition of water, EP-A-801124 is concerned with a dry mixture, used for fine soil injection grout preparation, the mixture comprising fillers which do not react with water, cement and deflocculant; on addition of water, an agglomerate-free fine grout is formed, and this is easily injected into fine soil.

Thus, the use of such grouting materials in—primarily—civil engineering is well known, and its use in treating fine particulate sized wastes in the nuclear industry is the subject of WO-A-03/056571. Subsequently, in WO-A-04/06268, it is disclosed that cured cementitious materials may advantageously be employed for the long term encapsulation of uranium and Magnox fuel elements, as well as fuel element debris and other nuclear fuels, thereby providing a product which remains stable and monolithic for many hundreds of years. Hence, there is provided a treatment method which affords much greater efficiency, convenience and safety in handling, and has a consequent beneficial effect both in terms of environmental considerations and cost, thereby satisfying a long felt need in the nuclear industry wherein the waste management of materials is receiving ever greater attention in the global drive to ensure ever higher safety standards.

The method of WO-A-04/06268 comprises treating a nuclear material with an encapsulant which comprises a cementitious material and curing said cementitious material, the nuclear material generally comprising a nuclear fuel material such as uranium metal or Magnox fuel elements, fuel element debris, fast reactor fuel, metal oxide fuel or mixed oxide fuel, and the cementitious material typically comprising Portland Cement or a similar commercially available product to which one or more additional inorganic fillers may optionally be added, suitable fillers including blast furnace slag, pulverised fuel ash, hydrated lime, finely divided silica, limestone flour and organic and inorganic fluidising agents. The claimed invention also provides a method for the storage of a nuclear material which comprises encapsulation of the material in a cured cementitious material, and thereby offers a safe and convenient alternative means of handling other than nuclear fuel reprocessing.

Whilst the methods known from the prior art are generally satisfactory in dealing with materials of the type described, it is known that difficulties are often encountered when uranium metal is encapsulated in cementitious materials. The problems which arise are related to the corrosion of the uranium metal, which occurs at a very rapid rate in standard cementitious materials. This corrosion leads to the generation of hydrogen, which is liberated as the gas in the event that no oxygen is present in the system. Clearly, such chemical activity has severe implications for the long term stability of the concrete monolith, as well as creating very evident safety hazards.

The present inventors have therefore, addressed the problem of uranium corrosion when the metal is encapsulated in cementitious materials for long term storage and have found that it is possible to reduce the rate of corrosion of the uranium metal in such an environment, thereby allowing for the production of concrete monoliths having excellent long term stability, which show considerable environmental benefits, as well as alleviating the health and safety concerns associated with the handling of such materials. Thus, there is provided a process for the encapsulation and storage of uranium metal which overcomes the disadvantages of the prior art methods, which are associated with the corrosion of the metal, and provides for the safe long term storage of this material.

### STATEMENTS OF INVENTION

According to the present invention, there is provided a method for the encapsulation of uranium metal which comprises treating the metal with an encapsulant which comprises a cementitious material and curing said cementitious material, wherein said process additionally comprises the provision of means for the minimisation of the corrosion of said metal.

Optionally, said uranium metal may be comprised in waste material. Preferably, said means for the minimisation of the corrosion of said metal comprises means for the prevention of the corrosion of said metal.

In a first embodiment of the invention, a particularly suitable mode for the provision of means for the minimisation of corrosion comprises the provision of a source of oxygen within the cement matrix, either by the enhancement of oxygen access from the atmosphere or by the inclusion of an independent source of oxygen. In either case, the rate of corrosion is significantly reduced and the generation of hydrogen is prevented.

According to a second embodiment of the invention, an alternative mode for the provision of means for the minimisation of corrosion comprises facilitating the minimisation of the water content of the matrix, which ensures that less free water is available to promote corrosion of the uranium metal after hydration of the cementitious material has taken place.

A third embodiment of the invention envisages a combination of the different modes for the provision of means for the minimisation of corrosion as provided by the first and second embodiments of the invention.

### DESCRIPTION OF THE INVENTION

A preferred means for the provision of a source of oxygen within the cement matrix comprises facilitating enhanced oxygen access from the atmosphere, which may conveniently be achieved by the incorporation of at least one air entraining agent in the cementitious material. Typical air entraining agents include anionic or non-ionic surfactants. Alternatively, the cementitious material may comprise cenospheres, which comprise the hollow spheres found to occur in materials such as Pulverised Fuel Ash (PFA). In either case, enhanced oxygen ingress into the matrix from the atmosphere results in significantly reduced rates of corrosion and prevents generation of hydrogen.

A further preferred means for the provision of a source of oxygen within the cement matrix comprises the inclusion of an independent source of oxygen in the matrix. Typical examples of such sources include peroxides, preferably inorganic peroxides. Suitable inorganic peroxides for this purpose are peroxides of metals from Group II of the Periodic Table, such as calcium peroxide or magnesium peroxide. Again, the inclusion of these additional sources of oxygen results in significantly reduced rates of corrosion and prevents generation of hydrogen.

A further mode for the provision of means for the minimisation of corrosion comprises facilitating the minimisation of the water content of the matrix, which may conveniently be achieved by, for example, the addition of superplasticisers. Examples of suitable superplasticisers include surfactants such as polyacrylates or polycarboxylates. As a consequence of the addition c f the said superplasticisers, the fluidity of the cementitious grout mixture is increased, and the amount of water required for its preparation is reduced; the water which is present is converted to solid metal hydroxides during the process of hydration of the cementitious material. Thus, less free water is available to cause corrosion following completion of the cementation process.

The cementitious material may typically comprise, for example, Portland Cement or a similar commercially available product.

One or more additional fillers may optionally be added to the cementitious material; suitable fillers include sulphide-free fillers such as, for example, pulverised fuel ash, finely divided silica and organic and inorganic fluidising agents. Sulphide-containing fillers, such as blast furnace slag, which find application in the cementation of certain nuclear materials, are generally not suited to those embodiments of the process of the present invention which rely on the provision of a source of oxygen within the cement matrix, in view of the reactivity of the sulphide group with oxygen, which leads to the depletion of the oxygen.

The invention also provides a method for the storage of uranium metal which comprises encapsulation of the metal in a cured cementitious material comprising means for the minimisation of the corrosion of said metal.

A particular example of the application of the method involves placing the uranium metal in an appropriate container and adding a suitable cementitious material comprising means for the minimisation of the corrosion of said uranium metal. Said metal may be provided in any physical shapes or sizes, and may either be arrayed in the container or mixed haphazardly. The cementitious material is then added and allowed to at least partially cure, whereupon the container may then be capped or, alternatively, sent directly for storage or final disposal. The capping process involves placing a cap of cement on top of the mixture of uranium metal and cementitious material in the container after this mixture has been allowed to partially cure; the procedure has proved to be especially valuable in ensuring the safe long term storage of the metal, and it provides an additional benefit in the reduction of secondary waste. The cement used to form the cap comprises a cementitious material comprising means for the minimisation of the corrosion of said metal.

The container may comprise any container of an appropriate form and size, for example a drum having a capacity in the region of 500 litres. Typically, the cementitious material is provided in the form of an aqueous composition with a water content preferably in the region of 30-50% (w/w), to which said means for the minimisation of the corrosion of said metal is added. The content of said means for the minimisation of the corrosion of said metal is dependent on the precise means which is in use, but typical quantities, relative to the weight of cementitious material, would be in the region of 0.01-2% (w/w) air entraining agent, or 0.01-30% (w/w) cenospheres, or 0.01-10% (w/w) peroxide, or 0.01-5% (w/w) superplasticiser. In the event that the cementitious material comprises a superplasticiser, the water content of the mixture is preferably reduced, and is in the region of 10-50% (w/w). In any event, the cementitious grout material may conveniently be pumped under pressure into the container.

Mixing of the cementitious material with the means for the minimisation of corrosion of the metal may be effected in the container into which the uranium metal is placed, in which case the means for the minimisation of corrosion of the metal is preferably added to the container prior to the addition of the cementitious material. Alternatively, the mixing process may be carried out externally, prior to the introduction of the cementitious material into the container. External mixing may either be performed in a batchwise fashion, optionally at a remote location, prior to commencement of the process which comprises the method of the invention, or may take place in-line, preferably immediately prior to the introduction of the cementitious material into the container.

1. A method for the encapsulation of uranium metal which comprises treating the metal with an encapsulant which comprises a cementitious material and curing said cementitious material, wherein said process additionally comprises the provision of means for the minimisation of the corrosion of said metal.

2. A method as claimed in claim 1 wherein said uranium metal is comprised in waste material.

3. A method as claimed in claim 1 wherein said means for the minimisation of the corrosion of said metal comprises means for the prevention of the corrosion of said metal.

4. A method as claimed in claim 1 wherein the mode for the provision of said means for the minimisation of corrosion comprises the provision of a source of oxygen within the cement matrix.

5. A method as claimed in claim 4 wherein the provision of said source of oxygen within the cement matrix comprises facilitating enhanced oxygen access from the atmosphere.

6. A method as claimed in claim 4 wherein the provision of said source of oxygen within the cement matrix comprises the inclusion of an independent source of oxygen.

7. A method as claimed in claim 1 wherein the mode for the provision of said means for the minimisation of corrosion comprises facilitating the minimisation of the water content of the matrix.

8. A method as claimed in claim 5 wherein enhancement of oxygen access from the atmosphere is achieved by the incorporation of at least one air entraining agent in the cementitious material.

9. A method as claimed in claim 8 wherein said air entraining agent comprises at least one anionic or non-ionic surfactant.

10. A method as claimed in claim 8 wherein said cementitious material comprises 0.01-2% (w/w) of an air-entraining agent.

11. A method as claimed in claim 5 wherein enhancement of oxygen access from the atmosphere is achieved by the incorporation of cenospheres in the cementitious material.

12. A method as claimed in claim 11 wherein said cementitious material comprises 0.01-30% (w/w) of cenospheres.

13. A method as claimed in claim 6 wherein said independent source of oxygen comprises at least one peroxide.

14. A method as claimed in claim 13 wherein said peroxide comprises an inorganic peroxide.

15. A method as claimed in claim 14 wherein said inorganic peroxide comprises a peroxide of a metal from Group H of the Periodic Table.

16. A method as claimed in claim 15 wherein said peroxide comprises calcium peroxide or magnesium peroxide.

17. A method as claimed in claim 13 wherein said cementitious material comprises 0.01-10% (w/w) peroxide.

18. A method as claimed in claim 7 wherein the means for facilitating the minimisation of the water content of the matrix comprises the addition of at least one superplasticiser to the cementitious material.

19. A method as claimed in claim 15 wherein said at least one superplasticiser comprises at least one surfactant.

20. A method as claimed in claim 19 wherein said surfactant comprises a polyacrylate or polycarboxylate.

21. A method as claimed in claim 18 wherein said cementitious material comprises 0.01-5% (w/w) of superplasticiser.

22. A method as claimed in claim 1 wherein said cementitious material comprises Portland Cement.

23. A method as claimed in claim 1 wherein the cementitious material additionally comprises one or more fillers.

24. A method as claimed in claim 23 wherein said filler is selected from pulverised fuel ash, finely divided silica and organic and inorganic fluidising agents.

25. A method as claimed in claim 1 wherein the cementitious material is provided in the form of an aqueous composition.

26. A method as claimed in claim 25 wherein the water content of the composition is in the region of 30-50% (w/w).

27. A method as claimed in claim 25 wherein the water content of the composition is in the region of 10-50% (w/w). 28. A method as claimed in any preceding claim wherein the uranium metal is placed in an appropriate container and a cementitious material is added and allowed to at least partially cure.

29. A method as claimed in claim 28 wherein the container is subsequently capped.

30. A method as claimed in claim 28 wherein the container comprises a drum having a capacity in the region of 500 litres.

31. A method as claimed in claim 1 which comprises mixing of said cementitious material with said means for the minimisation of the corrosion of said metal.

32. A method as claimed in claim 31 wherein said mixing is effected in the container into which the uranium metal is placed.

33. A method as claimed in claim 31 wherein said mixing is carried out externally to the said container.

34. A method as claimed in claim 33 wherein said mixing is performed in a batchwise fashion prior to addition of the cementitious material to the container.

35. A method as claimed in claim 33 wherein said mixing takes place in-line prior to the introduction of the cementitious material into the container.

36. A method for the storage of uranium metal which comprises encapsulation of the material in a cured cementitious material comprising means for the minimisation of the corrosion of said metal.
